(19) United States
(12) Patent Application Publication
(10) Pub. No.: US 2002/0013633 A1
(43) Pub. Date: Jan. 31, 2002

(54) Audio processor and audio data processing method

(76) Inventor: Tomoya Kodama, Kawasaki-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/915,348

(22) Filed: Jul. 27, 2001

(30) Foreign Application Priority Data
Jul. 28, 2000 (JP) 2000-229153

(51) Int. Cl. G06F 17/00

(52) U.S. Cl. 700/94

(57) ABSTRACT

An audio processor comprises a control device which fetches in, when executing one process, a program and data stream corresponding to next process from an external memory device, an internal memory which stores the program and data stream read from the external memory device and corresponding to the one and next one of the processes, and a processor which subject the input data stream to the process based on the program and data stream read from the internal memory.

### CROSS-REFERENCE TO RELATED APPLICATIONS

This application is based upon and claims the benefit of priority from the prior Japanese Patent Application No. 2000-229153, filed Jul. 28, 2000, the entire contents of which are incorporated herein by reference.

### BACKGROUND OF THE INVENTION

1. Field of the Invention

The present invention relates to an audio processor and audio data processing method, particularly an audio decoder which decodes encoded audio signal input from broadcast or storage media, and an audio encoder which encodes an audio signal.

2. Description of the Related Art

In recent years, technology for encoding digital video data and digital audio data has been established. The encoded data is utilized in broadcast and storage media. Further, together with development of the LSI technology, it becomes possible to package on one chip a circuit having millions of gates to tens of millions of gates.

From this fact, an LSI device is demanded which realizes decompression of digital compressed video and audio data and back-end processing of graphics or the like, and recompression of further decompressed video and audio data. Such LSI device is connected to a memory having ten or more Mbits or tens of Mbits to be configured into a UMA (Unified Memory Architecture) in which the video processing and audio processing share the memory.

Particularly, in the audio processing, it is desirable that the Dolby AC-3 Standard, the Linear PCM Standard, Digital Theater System (DTS) Standard and the like are present. Thus, decoding based on all these standards is preferable. Furthermore, in digital BS broadcasting in Japan, it is necessary to perform the decoding based on the MPEG-2AAC standard. Thus, it is necessary to correspond to various methods in accordance with applications.

From this background, in the conventional one chip audio video (AV) decoder, a dedicated digital signal processor (DSP) is mounted for audio processing so that the decoding is performed on the basis of software. On the other hand, for suppressing the cost, there is a demand for decreasing the scale of LSI circuit. In the DSP, the frequency transformation (FFT: fast Fourier transformation) and the filter processing can be performed at a high speed with the result that two or more local memories and memory access units and an arithmetic unit for address update are required to be provided in order to enable to realize the audio processing at a low operating frequency while to efficiently perform arithmetic processing. Thus the circuit scale including the memory is not small at all.

Furthermore, when processing other than audio processing such as, for example, communication with a host CPU and the control of the external hardware module or the like are performed, DSP is inefficient and a surplus hardware resource is consumed in many cases. Consequently, this configures a factor of raising the cost of the whole LSI (larges-scale integration).

With respect to such a problem, in the video/audio decoder on the MPEG standard, there is proposed a method for realizing audio processing and video processing on the same hardware by providing one processor arranged on a bus as well as a signal processing unit for performing an inverse modified discrete transformation (IMDCT) of audio data to simultaneously perform the processor and the signal processing unit.

Furthermore, there is proposed a method for realizing real-time processing by dividing an output portion of the video and audio information from the input of the bit streams generated asynchronously with the decoding and controlling with an independent processor to alleviate a burden of a decoding device.

According to the prior art, there are available a method for processing both video and audio data with one processor and a method for separately performing input/output processing with dedicated processors.

In the case of the former method, since the processor must perform the processing of both video and audio data, a high processing capability is demanded. Consequently, a high operation frequency is demanded, which invites an increase in the cost. In this method, there is a tendency that an area occupied by the memory arranged on the periphery of the processor is enlarged, which invites an increase in the cost. Furthermore, a control circuit is required which is on the same level as the CPU and a high function arithmetic unit is also required in order that the signal processor itself can operate independently.

That is, in a butterfly calculation for audio, a calculation precision on the order of 24 bits is required and the frequency of butterfly calculation thereof may be on the level of millions of times per one second. On the other hand, precision in the case of video may be on the order of 12 bits but the butterfly calculation thereof must be performed tens of millions of times per one second. In order to establish the two calculations, the signal processing unit must have a high precision and a high speed with good quality. Thus, there is a possibility that the circuit scale is large and the cost comes high.

Furthermore, in the latter method, a processing is performed by using a dedicated processor for inputting and outputting video and audio information. However, the processing of video data and audio data must be alternately performed with a decoding device, so that high performance hardware is demanded to establish both audio processing for which a high precision is demanded and video processing for which high speed is demanded. When only the audio processing is allowed to be independent, the input/output rate of the audio is sufficiently low, virtually no effect is produced by dividing a decoding device from the input/output device. Furthermore, since a required amount of memory increases as a result of the division of the decoding device from the input/output device, there is a problem that a chip area increases as a result.

In order to decrease memory amount, there is considered a method for improving a memory access with a cache memory by using a memory connected to the outside as a first recording medium in place of a memory which is locally arranged. When the cache memory is not hit, the external memory should be referred to. Since the external memory is originally slower than the internal memory in access speed and is shared with, for example, video processing, a large delay is generated when the cache memory is not hit. This becomes fatal in applications such as audio processing or the like in which real time processing must be performed.

### BRIEF SUMMARY OF THE INVENTION

It is an object of the present invention to provide an audio processor for processing audio data of an input data stream using programs and data fetched from an external memory device.

According to a first aspect of the present invention, there is provided an audio processor which processes audio data of an input data stream via an external memory device, comprising: a control device connected to the external memory device which stores programs and data streams used for sequentially executing a plurality of processes, the control device being configured to fetch in, when executing one of the processes, a program and data stream corresponding to next one of the processes from the external memory device; an internal memory connected to the control device and configured to store the program and data stream read from the external memory device and corresponding to the one and next one of the processes; and a processor connected to the internal memory and configured to subject the input data stream to the process based on the program and data stream read from the internal memory.

According to a second aspect of the present invention, there is provided an audio data processing method for processing audio data of an input data stream, comprising: preparing an external memory device which stores programs and data streams used for sequentially executing a plurality of processes; fetching in, when executing one of the processes, a program and data stream corresponding to next one of the processes from the external memory device; storing the program and data stream read from the external memory device and corresponding to the one and next one of the processes in a memory; and subjecting the input data stream to the process based on the program and data stream read from the internal memory.

### BRIEF DESCRIPTION OF THE SEVERAL VIEWS OF THE DRAWING

FIG. 1 is a block diagram showing an audio processor according to a first embodiment of the present invention;

FIGS. 2A and 2B are flowcharts for explaining an audio processing using DMA and audio processing without DMA;

FIG. 3 is a view for explaining a flow of decoding a bit stream based on the MPEG-2 AAC as an example of decoding an audio stream according to an embodiment of the present invention;

FIGS. 4A and 4B are views showing a state of a local memory at the time of the start of decoding bit streams according to an embodiment of the present invention;

FIG. 5 is a view showing a change in data memory in the bit stream decoding of the present invention; and

FIG. 6 is a block diagram showing an audio processor according to a second embodiment of the present invention, wherein an audio processor also serves as a video decoder.

### DETAILED DESCRIPTION OF THE INVENTION

A video/audio processor using an audio processor according to an embodiment of the present invention is based on a UMA method in which a memory accommodated in one chip and present in the outside is allowed to be shared in video processing and audio processing. As a basic concept, small capacity local memories (for example, an instruction memory, a data memory and an audio memory) are incorporated in an audio processor. This audio processor predicts processing which is to be performed at the next step to control a DMA controller so that required data program is transmitted from the external memory to the instruction memory in advance. Furthermore, this audio processor allows data which is determined to be unused for a long time to be saved from the local memory to the external memory 1 immediately after the generation of the data. Furthermore, the audio processor releases the storage region of the data or the program which becomes unnecessary.

Hereinafter, embodiments of the present invention will be explained by referring to the drawings.

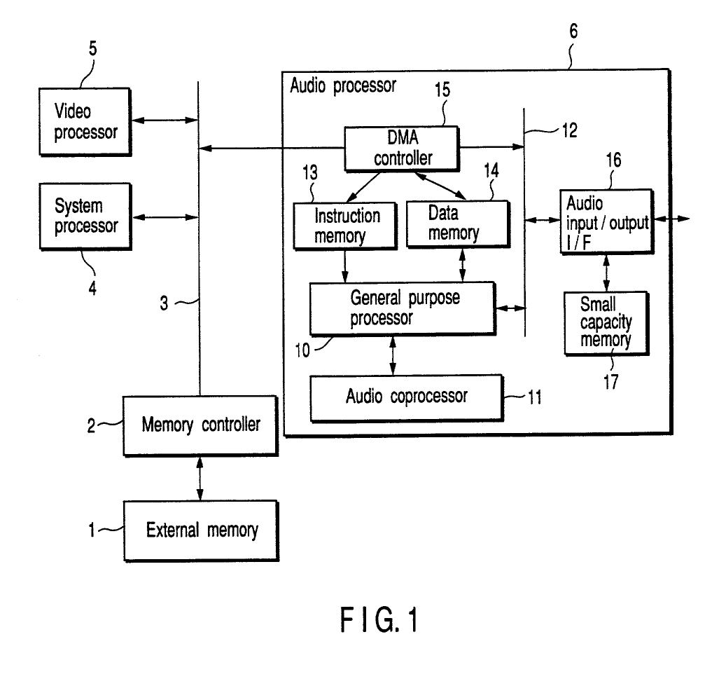

According to a first embodiment shown in FIG. 1, an external memory 1, a memory controller 2, a bus 3, a system processor 4, a video processor 5, and an audio processor 6 are provided. The audio processor 6 comprises s a general purpose processor 10, an audio coprocessor 11, a local bus 12, an instruction memory 13, a data memory 14, a DMA controller (direct memory access controller) 15 and an audio input/output interface 16 and a small capacity memory 17.

The general purpose processor 10, the DMA controller 15, and the audio input/output interface 16 are mutually connected via the local bus 12. The system processor 4, the video processor 5 and the audio processor 5 are mutually connected via the bus 3.

The external memory 1 is shared by the system processor 4, the video processor 5 and the audio processor 6. The external memory 1 stores data such as video or audio stream which is processed by the system processor 4. Further, the external memory stores instruction (program) for calculation processing which is performed by the general purpose processor 10 and data or the like required for the calculation processing or the like. The memory controller 2 controls an access of this external memory 1.

The system processor 4 performs processing of separating data stream (for example, MPEG-2 data stream) input as an input signal into a video stream and an audio stream, and writing such streams into different and independent memory regions of the external memory 1 respectively. The video processor 5 decompresses the video stream in the external memory 1, and outputs the decompressed stream to the outside at a predetermined timing.

The audio processor 6 subjects the audio stream in the external memory 1 to signal processing, and outputs the streams to the outside at a predetermined timing. This audio processor 6 comprises a general purpose processor 10, an audio coprocessor 11, a local bus 12, an instruction memory 13, a data memory 14, a DMA controller 15, an audio input/output interface 16 and a small capacity memory 17.

The audio coprocessor 11 is a coprocessor with respect to the general purpose processor 10, and reconstructs audio data obtained via the general purpose processor 10. When the audio bit stream data based on the MPEG-2 AAC, which is one of compression coding technology on the international standard, is decoded, decoding of bit stream data, noiseless decoding, inverse quantization processing, scale factor processing, TNS processing (the noise reduction processing), filter bank (or frequency-to-time conversion) (filtering processing with respect to the audio components), and block switching processing are in this order, to reconstruct audio data.

Furthermore, the instruction memory 13 stores an instruction code with respect to the general purpose processor 10. Furthermore, the data memory 14 stores various data to be processed by the general purpose processor 10.

Furthermore, the general purpose processor 10 performs processing in accordance with the instruction code stored in the instruction memory 13. In the embodiment, the general purpose processor 10 captures and buffers the data (audio streams) primarily required in the audio coprocessor 11. Then, the general purpose processor 10 fetches data such as various tables, a filter bank coefficient and the like corresponding to the progress stage of the audio data reconstruction processing, and delivers the data to the audio coprocessor 11. Further, the general purpose processor 10 stores data obtained by the audio coprocessor 11 in the data memory 14, and controls the DMA controller 15.

The DMA controller 15 controls the writing of data to the external memory 1, the instruction memory 13, and the data memory 14, and the reading of the data therefrom by DMA (Direct Access Memory) transfer. In other words, the writing and reading are performed by directly accessing designated memory address region, without access control based on an instruction from the general purpose processor 10.

The audio input/output interface 16 interfaces the audio signal. The small capacity memory 17 serves as a buffer at the time of the input/output of the audio signal by the audio input/output interface 16. since the small capacity memory 17 simply has several bytes to several tens of bytes, a part of the data memory 14 may substitute for the small capacity memory 17.

It is assumed that the apparatus according to the present embodiment is provided on a DVD (digital versatile disk) apparatus as a large capacity optical disk which can digitally record video data, sound, and data. A compressed video/audio stream based on the MPEG-2 system stream is decoded, and obtained video and audio signals are output to the outside.

The system processor 4, the video processor 5 and the audio processor 6 are incorporated in a LSI. Since the external memory 1 is connected to the outside of the LSI, the system processor 4, the video processor 5 and the audio processor 6 share one external memory 1.

Furthermore, although not shown in the drawings, there can be considered a case in which portion which performs other processing than the video back-end processing shares the external memory 1. The external memory 1 comprises, for example, a synchronous dynamic random access memory (SDRAM) or the like. The memory 1 has a relatively large capacity but is shared with a plurality of processors (the system processor 4, the video processor 5 and the audio processor 6). For this reason, a delay occurs from the issue of a request to the memory controller 2 for causing each processor to start the access until an actual access is performed.

In this embodiment, a plurality of program modules corresponding to a plurality of processes are sequentially fetched in the audio processor 6 from the external memory 1 according to the progress of the program module processing. As a result, the memory resource of the internal memories (13, 14, 17) required for the processing at the audio processor 6 is restricted to a minimum level. Furthermore, since the program module is fetched in the audio processor 6 in advance prior to the processing, the delay is substantially suppressed.

For example, in the case of bit stream decoding based on, for example, the MPEG-2 AAC, the audio data is reconstructed by executing the processing procedure of the decoding of bit stream data, the noiseless decoding, the inverse quantization, the scale factor, the TNS processing, the filter bank processing, and the block switching, in this order. Consequently, it is possible to predict which processing is performed after the processing which is currently performed. On the basis of this fact, in the external memory 1 is prepared for each process a program module which request the DMA controller 15 for preparing, while continuing the processing which is currently performed, data and an instruction group that are required for next processing. Furthermore, a DMA transfer instruction is added to the program module in order to read the program module used in the next processing from the external memory 1, the instruction allowing to read the program module with the DMA transfer by specifying the storage area. Thus, the required program module is read in advance and captured along with the progress of the processing, and an instruction group shown by the program configuring this program module is executed by the general purpose processor 10. Consequently, an instruction can be given to the DMA controller 15 in order to read, for each processing, the program module required for the next processing and required data along with the progress of the occasional processing.

That is, in the embodiment of the present invention, an on-demand method is adopted. According to the method, the objects (i.e., data and instruction) required for the next processing are prepared in advance in units of required minimum unit according to progress state of the processing. The prepared objects are used in the next processing. The memory capacity of the instruction memory 13 and the data memory 14 can be reduced. Further, the time required for reading the data is reduced.

Next, there will now be explained an action of the system having the above structure.

The MPEG-2 system stream is input as an input signal to the system processor 4. The system processor 4 separates the input stream into video and audio streams to be written into the different and independent memory regions of the external memory 1 respectively. The video stream written into the external memory 1 is subjected to the decompression at the video processor 5 to be output to the outside at a predetermined timing. In the same manner, the audio stream written into the external memory 1 is subjected to decompression at the audio processor 6 to be output to the outside at a predetermined timing.

As has been described above, the audio processor 6 is provided with the general purpose processor 10. A CPU core generally used for the incorporation into the device is used as the general purpose processor 10 in the audio processor 6. A instruction group which is executed by the general purpose processor 10 and a data group to be processed are stored in the external memory 1. The general purpose processor 10 appropriately controls the external memory 1 to transfer the instruction group to the instruction memory 13 and the data group to the data memory 14.

Next, the general purpose processor 10 uses the data stored in the data memory 14 based on the instruction group stored in the instruction memory 13 to give an instruction to the audio coprocessor 11 in order to perform audio processing. As a consequence, the audio coprocessor 11 performs audio processing having a designated content. After the processed result is temporarily buffered in the external memory 1 under the control of the general purpose processor 10, the result is subsequently written into the small capacity memory 17 in the audio processor 6 to be output to the outside through the audio input/output interface 16.

The general purpose processor 10 transfers the halfway result of the calculation which should be conserved to the external memory 1 by appropriately using the DMA controller 15 to be held.

### <DECODING OF THE AUDIO DATA>

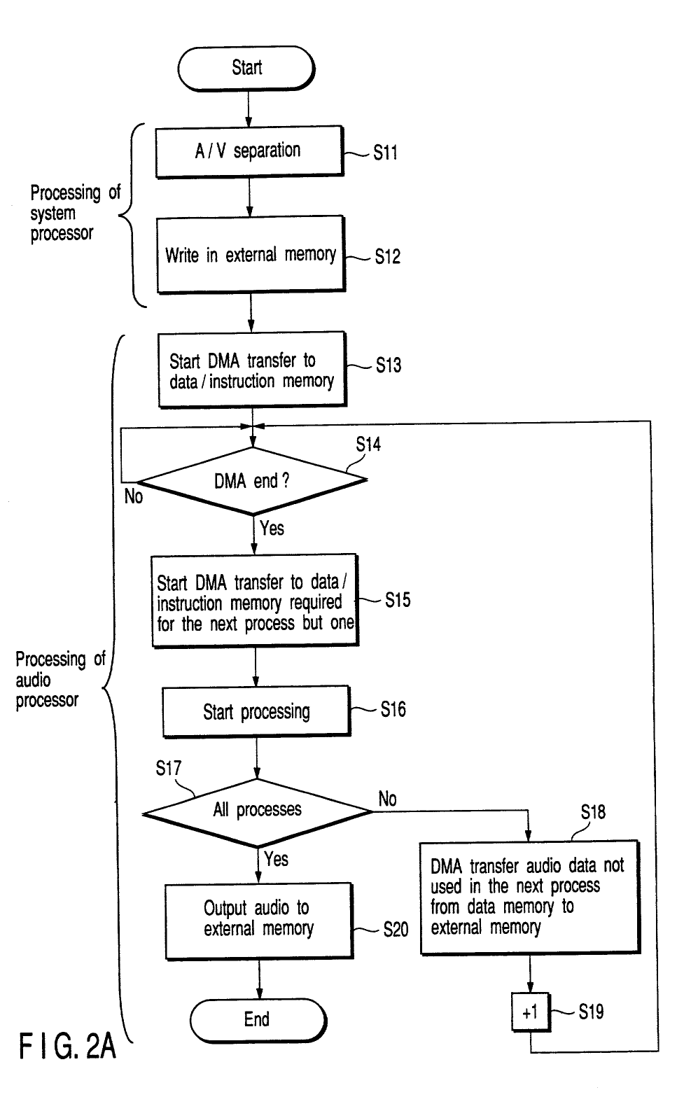

There will be explained an audio stream decoding performed by the audio processor 6. First, the entire operation of the audio processing is described with reference to FIG. 2A.

The input stream is separated into the video and audio streams (S11). The video and audio streams are written in the different and independent memory regions of the external memory 1 (S12). DMA-transferring from the external memory 1 to the data and instruction memories 13 and 14 is started (S13). It is determined whether or not DMA ends (S14). If DMA ends, DMA-transferring to the data and instruction memories 13 and 14 for next process but one is started (S15). Then, the process is started (S16). It is determined whether or not all processes are completed (S17). If all processes are not completed, the audio data not used in the next process is DMA-transferred from the data memory 14 to the external memory 1 (S18). The process is incremented by one (S19) and returns to the step S14. If all processes are completed, the audio data outputs to the external memory 1 (S20).

The operation of the audio processor without DMA-transfer is described hereinafter in conjunction with FIG. 2B.

The input stream is separated into the video and audio streams (S11). The video and audio streams are written in the different and independent memory regions of the external memory 1 (S12). The data and instruction are read from the external memory 1 (S21) and written into the data and instruction memories 13 and 14 (S22). Then, the process is started (S16). It is determined whether or not all processes are completed (S17). If all processes are not completed, the audio data not used in the next process is saved from the data memory 14 to the external memory 1 (S18). The process is incremented by one (S19) and returns to the step S14. If all processes are completed, the audio data outputs to the external memory 1 (S20).

As described above, while the current process is executed, the instruction and data of the next process are fetched in the audio processor 6 from the external memory 1.

Hereinafter, there is will be concretely described the audio decoding of audio data.

In the case of the structure shown in FIG. 1, this audio stream decoding is performed by the audio coprocessor 11, but the processing content is as follows.

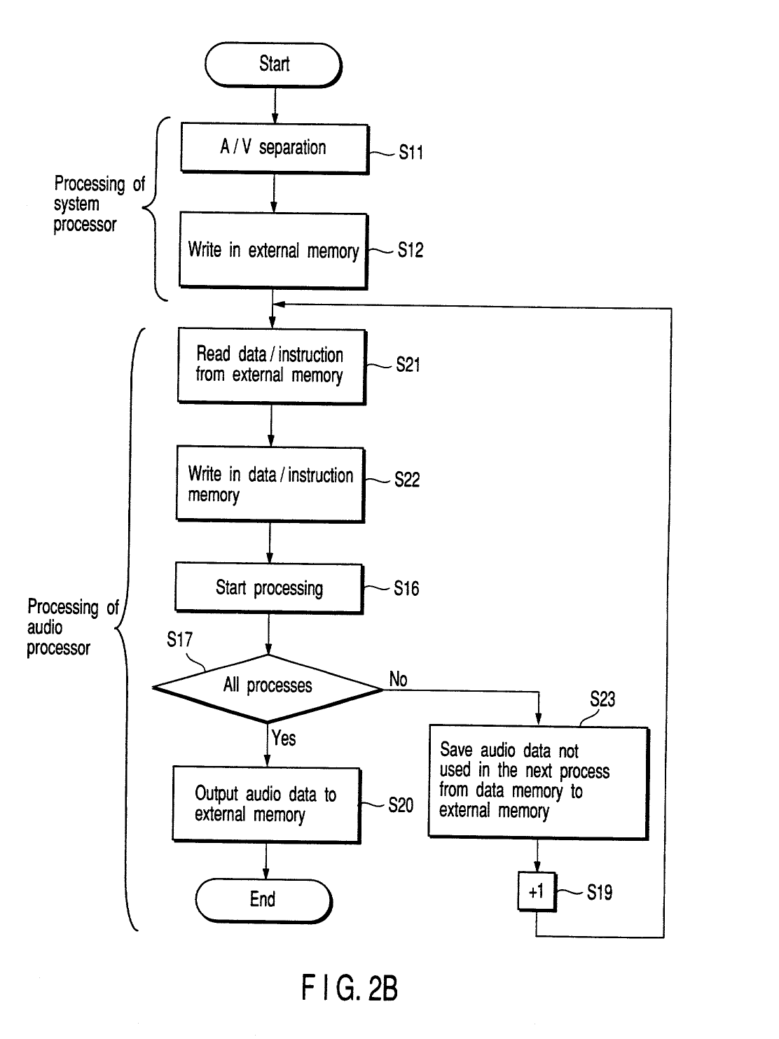

For example, as an example of decoding of audio streams, the flow of decoding of bit streams based on the MPEG-2 AAC is shown in FIG. 3. In the case of decoding of the MPEG-2 AAC bit streams, the processing is performed in the order of [1] the decoding of bit stream data 40, [2] the noiseless decoding 41, [3] the inverse quantization 42, [4] the scale factor 43, [5] the TNS (i.e., noise reduction processing) 44, [6] the filter bank (filtering professing with respect to the audio components) 45, and [6] the block switching 46.

Since this processing order is approximately fixed, it is easy to predict which processing is performed after the processing which is currently performed. Consequently, a demand is made on the DMA controller 15 so that data and an instruction group required for the next processing is prepared in advance while continuing the processing which is currently performed.

Consequently, in the system of the present invention, the general purpose processor 10 is provided with a function of allowing such prediction to be made and allowing a demand to be made on the DMA controller 15 for preparing in advance data and an instruction group required for the next processing at an optimal timing in consideration of the content of processing which is currently being performed and a progress situation.

Specifically, for example, the next processing is performed.

Currently, the capacity of the data memory 14, and the instruction memory 13 is set to D [bytes] and I [bytes] respectively, so that the decoding 40 of bit stream data is performed as the processing which is being performed. Data required for this is VLC (Variable Length Coding) table, and bit stream data and these items of the data are stored in the memory data 14.

The occupancy of the data memory 14 at this time is set to Di0 [bytes]. Furthermore, in the same manner, an instruction group required for the decoding of the bit stream data is stored in the instruction memory 13 in advance.

The occupancy of the instruction memory 13 at this time is set to I0 [bytes]. The decoding processing 40 of the bit stream data uses a work area of Dw0 on the data memory 14 by reading bit streams to perform a predetermined processing, thereby generating the Do0 [bytes] data.

Consequently, the occupancy of the data memory 14 used in the processing of the decoding 40 of the bit stream data is set to Di0+Dw0+Do0 [bytes] while the occupancy in the instruction memory 13 is Ii0 [bytes].

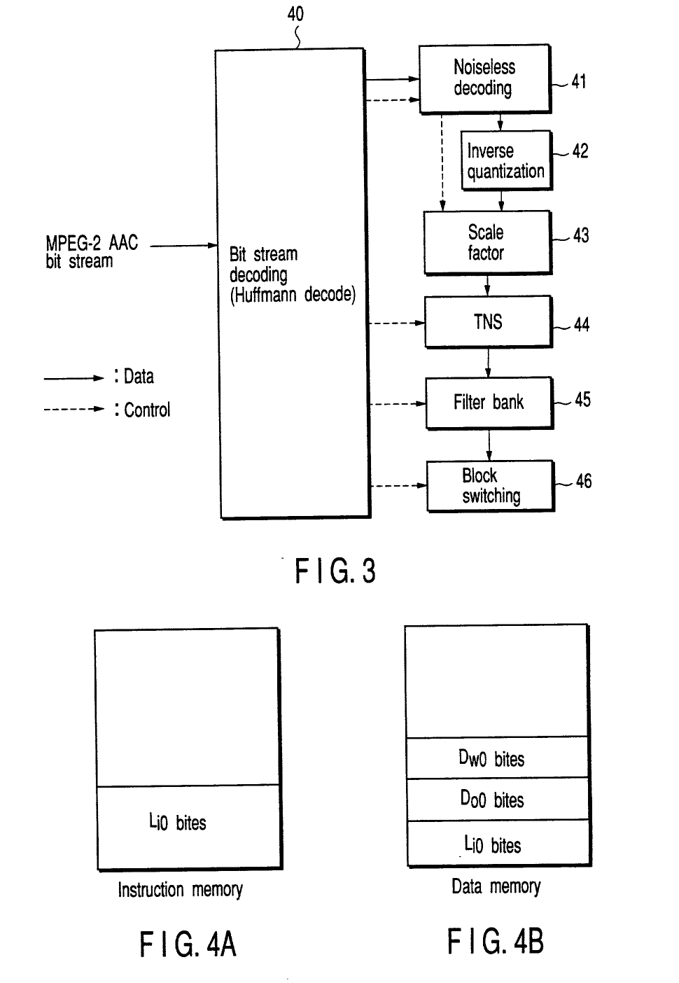

The states of respective memories at this time are shown in FIGS. 4A and 4B. That is, the occupancy state on the instruction memory 13 is as shown in FIG. 4A. The occupancy state on the data memory 14 is as shown in FIG. 4B.

The memory required in the next processing increases in the following manner in this state. That is, although the processing next to the bit stream data decoding processing is a processing of the noiseless decoding, the data required for the noiseless decoding is the Do0 [bytes] data obtained in the decoding of the bit streams, and the Dfl [bytes] data table data (data required for square multiplication) required for noiseless recording. Furthermore, in this processing, a work area for the Dwl [bytes] on the data memory is used to replace the data of Dol=Do0 [bytes]. Furthermore, the size of the instruction group required for the noiseless decoding is set to I1 [bytes].

Consequently, at this stage, in the data memory 14, the memory space for Di0 [bytes] is further required. In the instruction memory 13, the memory space for the I0 [bytes] becomes necessary.

That is, when the memory capacity in the data memory 14 satisfies the condition of D>Di0+Dw0+Do0+Di1, and the memory capacity I satisfies the condition of I>I0+I1 in the instruction memory 13, the instruction group and the data group used in the noiseless decoding can be transmitted in advance during the bit stream decoding.

Then, when the bit stream decoding is started, the general purpose processor 10 controls to make a reservation of sending an instruction to the DMA controller 15, transferring I1 [bytes] instruction group required for the noiseless decoding to the empty area of the instruction memory 13 and reading Di1 [bytes] data required for the noiseless decoding to the empty area of the data memory 14.

When the bit stream decoding is started, not at the stage of the noiseless decoding, it is important that such control is performed by the general purpose processor 10.

Generally, in the case of the UMA structure in which the external memory 1 is shared with the video processor 5 and the system processor 4, a certain degree of delay is generated in the access to the external memory 1. As a consequence, after sending an instruction to the DMA controller, a delay is generated until the memory transfer is started. If the instruction is sent in order to transfer the required memory to the DMA controller 15 immediately before the noiseless decoding is started, during this delay, the general purpose processor cannot perform processing. This delay time portion is a wasted time.

However, like the present invention, when an instruction is sent to the DMA controller in advance at the time of the bit stream decoding which is processing at the stage prior to the noiseless decoding, the delay is concealed, and the general purpose processor 10 can continue operation during the two processings with the result that the waste time is eliminated and the processing speed is improved.

Furthermore, in the case where data is present which is not used in the noiseless decoding at the next stage, and which should be conserved to be used at the processing at the latter stage out of data generated at the bit stream decoding, an instruction is sent from the general purpose processor 10 to the DMA controller 15 to be saved in the external memory 1 immediately after the bit stream decoding. By doing so, the saved region can be used as a new data region immediately after the noiseless decoding.

Thereafter, in the same manner, the general purpose processor 10 is controlled in such a manner that when the k-th processing is started, the content of the data memory 14 unnecessary for the k-th processing out of the k-1-th processing results is saved in the external memory 1, the instruction group required for the k+1-th processing and data are transferred to the instruction memory 13 and data memory 14 from the external memory 1. As a consequence, the audio coprocessor 11 is capable of decreasing the memory capacity required for performing audio processing with respect to the audio streams. Incidentally, symbol k denotes an arbitrary integer.

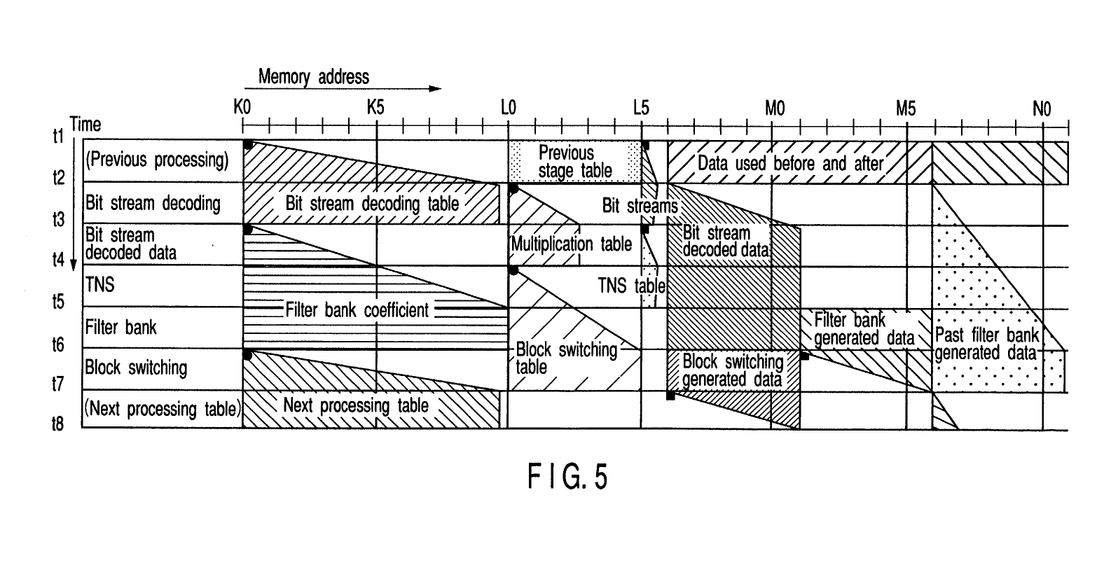

FIG. 5 shows an example of time transition of the data memory 14 in the MPEG-2 AAC decoding processing. In FIG. 5, the horizontal axis denotes a memory address while the vertical axis denotes time, respectively. Furthermore, the point shown by a black round mark denotes a start time of each processing while the black square mark denotes a start time of the DMA transfer. A graph shown in FIG. 5 shows which data in the processing from which time up to which time occupies which address space in the data memory 14. Consequently, FIG. 5 is a view showing a state transition of the memory space in the data memory 14 along with the transition of the processing.

In FIG. 5, the processing unit is divided into five stages [stage 1] the bit stream decoding, [stage 2] the noiseless decoding, the inverse quantization, and the scale factor processing, [stage 3] the TNS processing, [stage 4] the filter bank processing, and [stage 5] the block switching.

For example, at the time of t5, the filter bank processing which is the processing at [stage 4] is started. However, the filter bank coefficient which is required for the filter bank processing is started to be read from the external memory 1 with the control of the DMA controller 15 (at the time shown by a black round mark in FIG. 5) when the noiseless decoding is started which is a processing [stage 2] started at the time of t3. The storage location on the data memory 14 of the filter bank coefficient read from the external memory 1 is a memory space from the address K1 to the address L0.

The generated data by the filter bank processing is stored in the memory space from the address M1 to M6 on the data memory 14. After the filter bank processing is performed, the generated data stored in the memory space from the addresses M1 to M6 is used in the block switching which is the next processing [stage 5] started at the time of t6 while the data is also used in the processing after one block (1024 samples). Consequently, before the block switching is started, the DMA controller 15 is controlled (black square mark in the figure) to start the transfer and write to the external memory 1. Therefore, the block switching which is processing at [stage 5] is executed, at the same time, the transfer to the external memory 1 is performed.

Incidentally, in the case where an access to the instruction memory 13 or the data memory 14 with the general purpose processor 10 contends to each other when an access is made to the instruction memory 13 or the data memory 14 with the DMA controller 15, the processor operation is temporarily suspended during the contention. Since the time of the DMA transfer can be short, the degree of influence upon the audio processing is smaller when the access by the processor 10 is suspended.

Here, the audio processor according to the embodiment is not applied to the signal processor (DSP) which is conventionally widely used, but applied to a structure in which the general purpose processor is used. This is because the memory efficiency is sacrificed for realizing a high calculation efficiency in the DSP.

For example, in the DSP, it is general that at least two memory load units are provided in order to perform multiplication of the two elements. Consequently, two or more data memories are required in order to realize a sufficient performance in the DSP.

In contrast, according to the present embodiment, since the processor used in the audio processing is a general purpose processor, one data memory 14 will do. Furthermore, the general purpose processor is inferior to the DSP in the processing performance with respect to the multiplication/accumulation addition (MAC). In order to attempt to heighten the performance of the multiplication/accumulation addition (MAC), the audio coprocessor is arranged as an auxiliary function on the general purpose processor 10 according to this embodiment.

This coprocessor is driven with a method such as VLIW (Very Long Instruction Word; one of the techniques of arranging in parallel instructions which can simultaneously perform in advance when, for example, the program is compiled).

The data supply performance of the general purpose processor 10 may only have a throughput on the order which enables one time calculation per two clocks, that is, about a half of the performance of the coprocessor because the memory load unit has a half DSP.

With such a structure, even in the case where the multiplication/amplification addition in which the DSP is most efficiently operated continues, the performance difference can be only about ½ as compared with the DSP. Besides, all the audio processes are not occupied by the multiplication/amplification addition. Since the logical operation or addition/subtraction of the address are included therein, a gap in the performance difference between the DSP and the audio processor according to the present invention becomes smaller. For example, in the case of the MPEG-2 ACC decoding, since many processes are occupied by the multiplication/amplification addition in the TNS, the filter bank, and the block switching, the performance difference is large. On the other hand, a performance difference is not so large in the bit stream decoding 40, the noiseless decoding 41, the inverse quantization processing 42, and the scale factor processing 43.

Consequently, the actual performance difference with the DSP in the structure of the present invention becomes about ⅔. Besides, with the above memory transfer method, the required amount of the instruction memory 13 and the data memory 14 which are necessary in the audio processor in the embodiment can be largely decreased as compared with the DSP. The instruction and the data memory 14 may be integrally configured as a single memory. Furthermore, the method of the embodiment essentially using the general purpose processor 10 is smaller in the required hardware amount, and the operation at a high clock is easy. Consequently, it is possible to say that such degree of performance difference is no problem at all.

Incidentally, according to the present embodiment, the audio encoding method has been explained by taking an example of the MPEG-2 AAC decoding. However, the same control can be performed with respect to the decoding and the encoding of the MPEG1 audio and the Dolby AC-3 which are other encoding method.

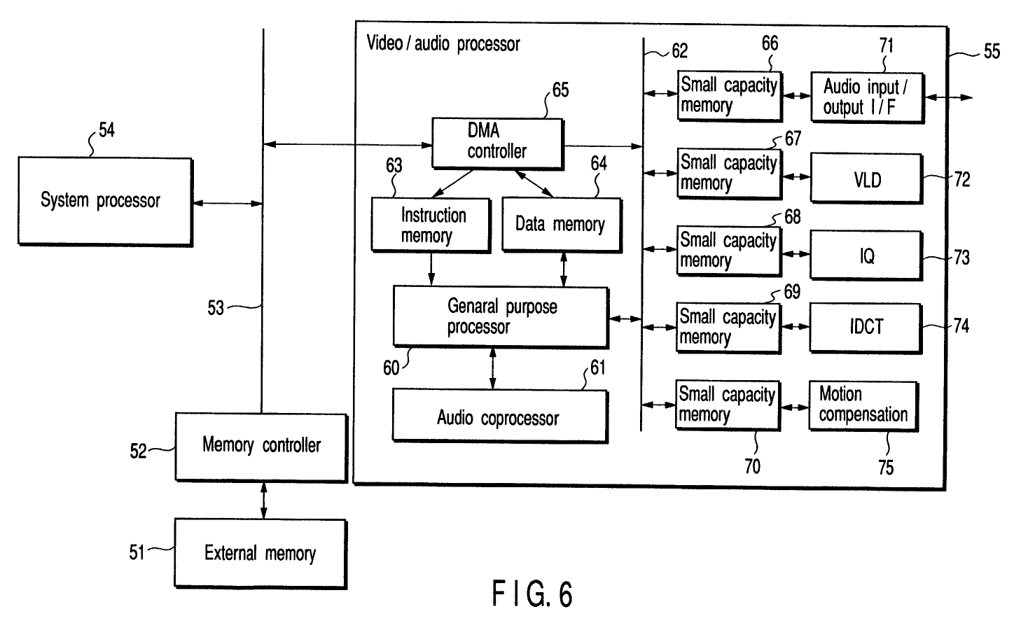

Furthermore, according to the above embodiment, there is shown an example in which the audio processor 6 performs only the audio bit stream decoding. In the case where the processing allowance amount of the processor has a room, it is possible to adopt a structure in which one processor serves both for the audio processing and video processing as shown in FIG. 6. That is, the structure shown in FIG. 6 comprises an external memory 51, a memory controller 52, a bus 53, a system processor 54, and a video/audio processor 55. The external memory 51, the memory controller 52, the bus 53 and the system processor 54 which correspond to the external memory 1, the memory controller 5, the bus 3 and the system processor 4 shown in FIG. 1, respectively.

The video/audio processor has both the video processing function and the audio processing function, that is, it is a unit of the video processor and the audio processor 6 shown in FIG. 1.

The video/audio processor 55 comprises a general processor 60, an audio coprocessor 61, a local bus 62, an instruction memory 63, a data memory 64, a DMA controller 65, small capacity memories 66 through 70, an audio input/output interface 71 and a VLD processor 72 for performing decoding of the bit streams, an IQ (inverse quantizer) 73 for performing inverse quantization, and an IDCT (inverse discrete cosine transformer) 74 for performing inverse discrete cosine transformation, a motion compensation device 75 for performing the motion compensation, and the like.

That is, the video/audio processor 55 shown in FIG. 5 shows a case in which the decode of audio bit streams and the decoding of the MPEG-2 bit streams are performed.

In the case of MPEG-2 bit streams, since the processing order is fixed, the processing can be applied in advance from the external memory 51 to the data memory 64 used for storing the data and the table and the instruction memory 63 for storing the instruction.

In the case of the vide processing, since the calculation amount is large, a large number of small capacity memories 67 to 70 are prepared. Furthermore, the arithmetic unit (VLD processor 72, the IQ (inverse quantizer) 73, the IDCT (inverse discrete cosine transformer) 74 and the motion compensation device 75) which perform calculation required for the MPEG-2 video bit stream decoding through these small capacity memories 67 to 70 are prepared while the general purpose processor 60 controls the DMA controller 65 to transfer data between the external memory 51 and the small capacity memories 67 to 70 and between the small capacity memories 67 to 70.

As a consequence, an extreme increase in the calculation amount of the general purpose processor 60 is suppressed to realize the video/audio decoding.

Incidentally, there has been explained a case in which the data processing apparatus according to the embodiment is applied to the DVD reproduction apparatus. However, the data processing apparatus according to the embodiment can be applied to a receiver, and to a sender or an encoder. The encoded bit streams supplied from the outside can be decoded to be applied to the decoder for outputting the decode result in a definite interval to the outside, or the digital data supplied from the outside can be encoded to be applied to an encoder for outputting the encode result to the outside.

As has been explained above, according to the present invention, in the case where the data processing using algorithm in which the processing order is approximately constant is used like algorithm of the audio processing, for example, the fact that this processing order is determined is noted, the arithmetic unit added with a coprocessor which does not require a circuit amount in the general purpose processor, a DMA controller for performing data transfer with the internal local memory and the external memory are arranged, and the DMA controller is controlled so as to transfer data required for the next processing and the instruction group in advance during the previous processing with the result that the data processing apparatus such as audio processor which is lower in cost than before can be realized.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An audio processor which processes an input data stream via an external memory device, comprising:
a control device connected to the external memory device which stores programs and data streams used for sequentially executing a plurality of processes, the control device being configured to fetch in, when executing one of the processes, a program and data stream corresponding to next one of the processes from the external memory device;
an internal memory connected to the control device and configured to store the program and data stream read from the external memory device and corresponding to the one and next one of the processes; and
a data processor connected to the internal memory and configured to subject the input data stream to the process based on the program and data stream read from the internal memory.

2. An audio processor according to claim 1, wherein the input data stream includes an audio data stream, and the data processor sequentially subjects the audio data stream to decoding, noise-less decoding, noise reduction, filter bank, and block switching in accordance with the programs and data streams read from the external memory device in units of one process.

3. An audio processor according to claim 2, wherein the data processor is configured to execute the program fetched in the internal memory from the external memory device in accordance with progress of the processes.

4. An audio processor according to claim 1, which includes a system processor which separates the input data stream into a video stream and an audio stream, and writes the video and audio streams into different and independent memory regions of the external memory device, respectively.

5. An audio processor according to claim 4, wherein the data processor is configured to subject the audio stream to signal processing according to the program.

6. An audio processor according to claim 5, wherein the internal memory comprises an instruction memory configured to store an instruction group of the program transferred from the external memory device and a data memory configured to store a data group transferred from the external memory device, and the data processor performs the process based on the instruction group using the data in the data memory and data corresponding to a progress stage of audio data reconstruction to generate audio data.

7. An audio processor according to claim 6, which includes a DMA controller configured to control writing of data to the external memory device, the instruction memory and the data memory, and reading of the data therefrom by a direct access memory transfer.

8. An audio processor according to claim 5, wherein the control device sequentially transfers a plurality of program modules corresponding to the plurality of processes to the data processor from the external memory device according to the progress of the processes.

9. An audio processor according to claim 5, wherein the data processor executes decoding of bit stream data, noiseless decoding, inverse quantization, scale factor, TNS processing, filter bank processing, and the block switching, in this order, to reconstruct audio data.

10. An audio processor according to claim 9, wherein the data processor includes a function of predicting which process is performed after the process which is currently performed.

11. An audio processor according to claim 7, wherein the internal memory stores a program module which request the DMA controller for preparing, while continuing the processing which is currently performed, the data group and instruction group that are required for the next process.

12. An audio processor according to claim 11, wherein a DMA transfer instruction is added to the program module in order to read the program module used in the next process from the external memory device, the DMA transfer instruction allowing to read the program module with the DMA transfer by specifying the storage area.

13. An audio processor according to claim 5, wherein the processor allows data which is determined to be unused for a long time to be saved from the internal memory to the external memory device.

14. An audio processor according to claim 13, wherein the processor releases the storage region of the data or the program which becomes unnecessary.

15. A data processing apparatus for processing an input data stream via an external memory device comprising:
a control device configured to fetch in programs for encoding and decoding, input/output data, work data, table data which are stored in the external memory device;
a data processor configured to perform data processing for coding or decoding according to the programs fetched by the control device;
a data memory configured to store the data fetched by the control device;
an instruction memory configured to store the programs to be applied to the processor; and
a DMA controller configured to transfer the data among the instruction memory and the data memory and the external memory,
the data processor controlling the DMA controller to perform the encoding and the decoding, read program and data required for the next process from the external memory, and write data obtained by the process into the external memory device.

16. An audio processor according to claim 15, wherein the data processor temporally stops when accessing of the DMA controller to the instruction memory or the data memory competes with accessing of the data processor to the instruction memory or the data memory.

17. An audio data processing method for processing an input data stream, comprising:
preparing an external memory device which stores programs and data streams used for sequentially executing a plurality of processes,
fetching in, when executing one of the processes, a program and data stream corresponding to next one of the processes from the external memory device;
storing the program and data stream read from the external memory device and corresponding to the one and next one of the processes in a memory; and
subjecting the input data stream to the process based on the program and data stream read from the internal memory.

18. A method according to claim 17, wherein the input data stream includes an audio data stream, and the subjecting step sequentially subjects the audio data stream to decoding, noise-less decoding, noise reduction, filter bank, and block switching in accordance with the programs and data streams read from the external memory device in units of one process.

19. An audio data processing method for sequentially subjecting input data to a plurality of processes, comprising:
storing a plurality of program modules corresponding to the plurality of processes and data to be processed in an external memory;
reading, when executing one process, a program module and data to be processed which are used for a next process from the external memory; and
processing the readout data in accordance with the readout program module.
